(19) United States
(12) Patent Application Publication
(10) Pub. No.: US 2026/0051446 A1
(43) Pub. Date: Feb. 19, 2026

(54) Switch Device, Handle Device, and Vehicle

(71) Applicant: Illinois Tool Works Inc., Glenview, IL (US)

(72) Inventor: Meng Wang, Shanghai (CN)

(21) Appl. No.: 19/299,827

(22) Filed: Aug. 14, 2025

(30) Foreign Application Priority Data
Aug. 15, 2024 (CN) 202411125852.3
Aug. 7, 2025 (CN) 202511105725.1

(51) Int. Cl. H01H 13/14; E05B 85/10; H01H 13/20

(52) U.S. Cl. CPC H01H 13/14; E05B 85/103; H01H 13/20

(57) ABSTRACT

A switch device, a handle device, and a vehicle. The switch device includes a housing with an opening, a switch positioned inside the housing, a button mounted at the opening, and a partially deformable intermediate element. The switch has a pressed portion that changes between an off state and an on state in response to a pressing force. When the button is pressed, it moves toward the switch, driving the intermediate element to press the pressed portion and switch it to the on state. After activation, the intermediate element allows the button to continue moving toward the switch for a short distance. This arrangement enables a user to open a door immediately after pressing the switch, eliminating delays and enhancing the user experience.

### RELATED APPLICATIONS

The present application claims the benefit of Chinese Patent Application Nos. 202411125852.3, filed Aug. 15, 2024, and 202511105725.1, filed Aug. 7, 2025, each titled “Handle Assembly and Vehicle,” the contents of which are hereby incorporated by reference.

### TECHNICAL FIELD

The present disclosure generally relates to the field of vehicles, and in particular to a switch device, a handle device, and a vehicle.

### BACKGROUND

In some vehicles, a push-button switch for generating a vehicle unlocking signal is provided in a handle device. The main function of the push-button switch is to turn on a built-in switch (such as a tact switch) of the push-button switch by pressing a button of the push-button switch, thereby generating an unlocking signal. After receiving the unlocking signal, a vehicle control device controls a physical lock rod to move for unlocking.

### SUMMARY OF THE DISCLOSURE

The present disclosure generally relates to a switch device, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a switch device according to a first embodiment of the present disclosure.

FIG. 1B is an exploded view of the switch device shown in FIG. 1A.

FIG. 1C is a cross-sectional view of the switch device shown in FIG. 1A along line A-A.

FIG. 2 is a perspective view of the switch device shown in FIG. 1A, with some components hidden.

FIG. 3A is a perspective view of an intermediate element of the switch device shown in FIG. 1B.

FIG. 3B is a side view of the intermediate element shown in FIG. 3A.

FIG. 3C is a cross-sectional view of the intermediate element shown in FIG. 3A along line B-B, with the intermediate element in an undeformed state.

FIG. 3D is a cross-sectional view of the intermediate element shown in FIG. 3A along line B-B, with the intermediate element in an intermediate deformed state.

FIG. 3E is a cross-sectional view of the intermediate element shown in FIG. 3A along line B-B, with the intermediate element in a final deformed state.

FIG. 4A is a cross-sectional view of the switch device shown in FIG. 1B along line C-C, with the switch device in an unpressed state.

FIG. 4B is a cross-sectional view of the switch device shown in FIG. 4A along line C-C, with the switch device in an intermediate pressed state.

FIG. 4C is a cross-sectional view of the switch device shown in FIG. 4A along line C-C, with the switch device in a fully pressed state.

FIG. 5 is an exploded view of a switch device according to a second embodiment of the present disclosure, with components such as a housing hidden.

FIG. 6A is a schematic view of a vehicle having a switch device of the present disclosure.

FIG. 6B is a partial perspective view of the switch device of the present disclosure mounted on a door.

FIG. 6C is a cross-sectional view of the switch device mounted on the door as shown in FIG. 6B along line D-D.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

It has been found through long-term observation and research that in the prior art, the button of the push-button switch needs to be pressed down to the bottom to trigger a built-in switch to generate an unlocking signal. Only after receiving the unlocking signal, a vehicle control device can control a lock rod to move so as to perform an unlocking operation. However, since the movement of the lock rod requires a certain amount of time, when the action of pressing the button is completed, the lock rod has not yet completed the unlocking operation. Therefore, a user needs to wait for a period of time after pressing the button before being able to pull open a door, resulting in a poor user experience.

In order to at least partially solve the above technical problems, according to a first aspect of the present disclosure, a switch device is provided, which includes a housing, a switch, a button and an intermediate element. The housing has an opening. The switch comprises a pressed portion and accommodated in the housing, the switch switches between an off state and an on state in response to a pressing force acting on the pressed portion. The button couples to the housing at the opening and is movable toward the switch upon application of a pressing operation. The intermediate element being at least partially deformable, the intermediate element is drivingly connected to the button, and operatively engaged with the pressed portion of the switch. The intermediate element is configured such that when the button is moved toward the switch upon application of the pressing operation, the intermediate element is driven by the button to press the pressed portion of the switch, so as to switch the switch to the on state, and after the switch is switched to the on state, the intermediate element allows the button to continue moving toward the switch for a distance.

According to the first aspect of the present disclosure, the intermediate element comprises: a transmission portion connected to the button and driven by the button; a pressing portion operatively engaged with the pressed portion of the switch; a holding portion holding the intermediate element in the housing; a first deformable connection portion connecting the transmission portion to the pressing portion; and a second deformable connection portion connecting the holding portion to one of the transmission portion, the pressing portion and the first deformable connection portion, and retaining the pressing portion in an initial position in which the pressed portion of the switch is not pressed.

According to the first aspect of the present disclosure, during application of the pressing operation, the button has a first-stage stroke and a second-stage stroke; wherein in the first-stage stroke, the button drives the transmission portion and the pressing portion to move toward the switch, so that the pressed portion of the switch is pressed by the pressing portion; and wherein in the second-stage stroke, the button continues driving the transmission portion to move toward the switch, and the pressing portion keeps pressing the pressed portion of the switch.

According to the first aspect of the present disclosure, each of the first deformable connection portion and the second deformable connection portion extends obliquely relative to a direction of movement of the transmission portion.

According to the first aspect of the present disclosure, the transmission portion is tubular shaped and comprises a cavity, wherein in the second-stage stroke, the pressing portion is gradually received into the cavity.

According to the first aspect of the present disclosure, the holding portion is a base supported by a bottom of the housing.

According to the first aspect of the present disclosure, the transmission portion, the pressing portion, the first deformable connection portion, and the second deformable connection portion together form a set of sub-elements, the intermediate element comprises two sets of sub-elements, and the two sets of sub-elements are held in the housing by the holding portion.

According to the first aspect of the present disclosure, the intermediate element is formed in one piece from an elastic material.

According to the first aspect of the present disclosure, the switch device further comprises: a push rod, the push rod is arranged between the button and the transmission portion of the intermediate element, such that opposite ends of the push rod abut against the button and the transmission portion of the intermediate element, respectively, so as to transmit the pressing force from the button to the transmission portion of the intermediate element.

According to the first aspect of the present disclosure, the button is rotatably connected to the housing to rotate toward the switch upon application of the pressing operation.

According to the first aspect of the present disclosure, the switch device further comprises: a return spring arranged to bias the button toward an initial position of the button.

According to the first aspect of the present disclosure, the switch device further comprises: an inner cover arranged in the housing and covering the intermediate element, the switch, and part of the push rod, wherein a guide hole is provided in the inner cover, the push rod extends out of the inner cover through the guide hole, and the button and the return spring are arranged outside the inner cover.

According to a second aspect of the present disclosure, a handle device for a door is provided. The handle device is provided with a switch device as aforementioned, the switch device being configured to generate an unlocking signal indicating that the door is to be unlocked upon application of the pressing operation on the button.

According to the second aspect of the present disclosure, the handle device comprises a handle seat comprising a handle cavity; wherein the switch device is arranged in the handle seat, in such a way that the button is located in the handle cavity, allowing the pressing operation applied to the button to be performed in the handle cavity.

According to a third aspect of the present disclosure, a vehicle is provided, which includes the handle device as aforementioned.

The switch device of the present disclosure enables the button to have a longer pressing stroke by arranging an at least partially deformable intermediate element for transmitting the pressing force between the button and the pressed portion of the switch. During pressing of the button, the switch can be turned on to generate an unlocking signal before the button is pressed down to the bottom. After the switch is turned on, the intermediate element can allow the button to continue moving toward the switch for a distance through deformation, and the time required for this process is the same as the time required for the physical unlocking of the lock rod. Thus, the lag time of the unlocking operation of the lock rod is compensated, so that the time when the pressing is completed is synchronized with the time when the lock rod completes unlocking. This allows the user to pull open the door without waiting for the lock rod to unlock after pressing the switch, resulting in a better user experience.

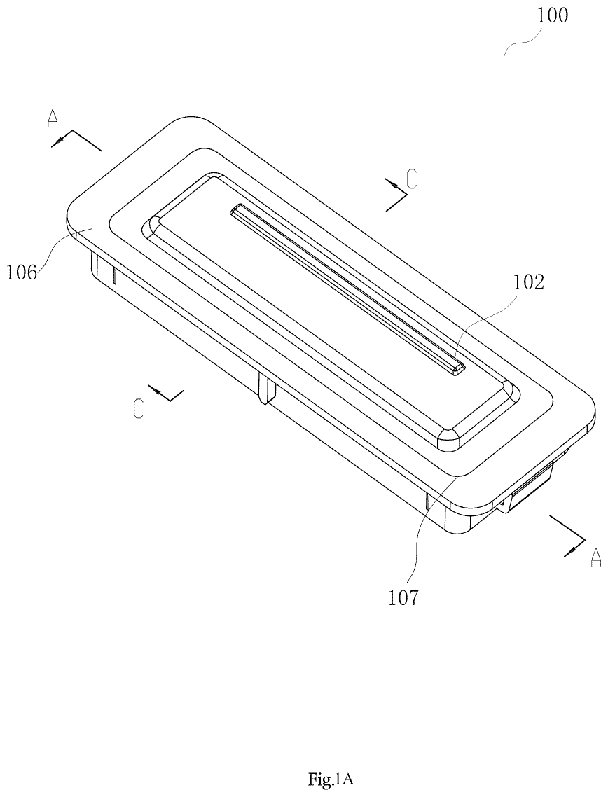

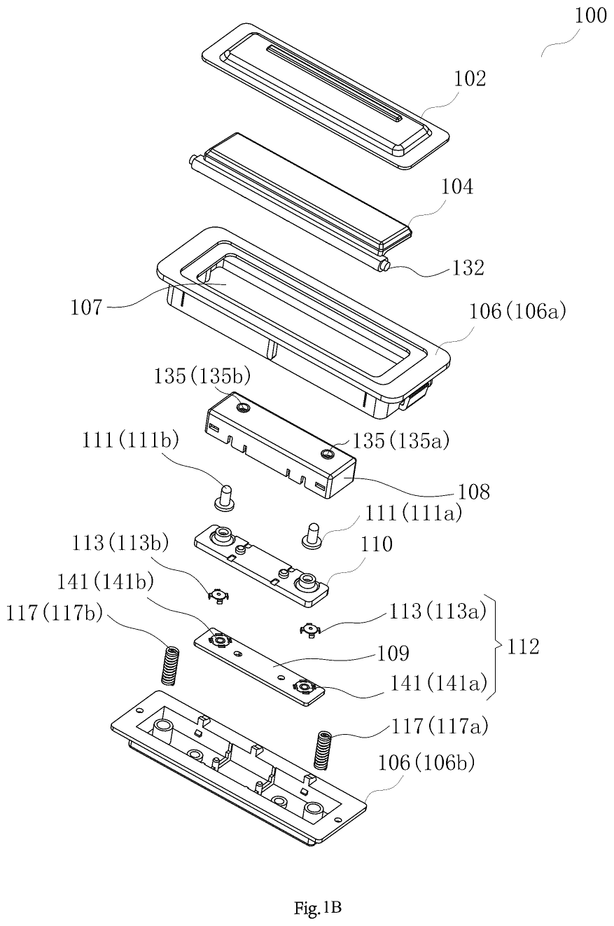

FIGS. 1A-1C show a specific structure of a switch device 100 according to a first embodiment of the present disclosure. FIG. 1A is a perspective view of the switch device 100 and FIG. 1B is an exploded view of the switch device 100. FIG. 1C is a cross-sectional view of the switch device shown in FIG. 1A along line A-A.

As shown in FIG. 1A, the switch device 100 has a housing 106. The housing 106 has an opening 107. The switch device 100 further includes a button cover 102 covering the opening 107 of the housing 106, and components accommodated in the housing 106. The button cover 102 is formed from a rubber layer.

As shown in FIGS. 1B and 1C, the housing 106 includes an upper housing 106a and a lower housing 106b. The opening 107 is defined by the upper housing 106a. The switch device 100 further includes a button 104, an inner cover 108, an intermediate element 110, a push rod 111, a switch 112, and a return spring 117, which are all accommodated in the housing 106. The button 104 is coupled to the housing 106 at the opening 107 and is movable toward the switch 112 upon application of a pressing operation. The button cover 102 covers an outer side of the button 104. When an operator presses the button cover 102, the pressing operation can be applied to the button 104, and the button cover 102 can provide a softer pressing feel. In the illustrated embodiment, the button 104 is rotatably connected to the opening 107 of the upper housing 106a via a pivot shaft 132, so as to rotate toward the switch 112 upon application of the pressing operation. It should also be understood by those skilled in the art that, in other embodiments, the button 104 may also be mounted to the opening 107 of the upper housing 106a in a sliding manner.

Still as shown in FIGS. 1B and 1C, the inner cover 108 is arranged in the housing 106 and covers the intermediate element 110, the switch 112, and part of the push rod 111. A guide hole 135 is provided in the inner cover 108, the push rod 111 extends out of the inner cover 108 through the guide hole 135, and the button 104 and the return spring 117 are arranged outside the inner cover 108. The intermediate element 110 is at least partially deformable, is drivingly connected to the button 104, and is operatively engaged with a pressed portion 113 of the switch 112.

Still as shown in FIGS. 1B and 1C, the switch 112 includes a pressed portion 113 and a circuit board 109 having a triggered portion 141 thereon. When no pressing force is applied to the pressed portion 113, the pressed portion 113 is separated from the triggered portion 141 on the circuit board 109, and the switch 112 is in an off state. When a certain pressing force is applied to the pressed portion 113, the pressed portion 113 undergoes elastic deformation to come into contact with the triggered portion 141 on the circuit board 109, and the switch 112 is in an on state. When the switch 112 is turned on, the switch 112 generates an unlocking signal, which is transmitted to a vehicle control device to perform an unlocking operation. Therefore, the switch 112 can switch between the off state and the on state in response to the pressing force acting on the pressed portion 113. In the illustrated embodiment, the pressed portion 113 is an elastic metal sheet, such as a metal dome. It should also be understood by those skilled in the art that, in other embodiments, the pressed portion 113 may be also other components that can elastically deform under a pressing force.

When the button 104 is moved toward the switch 112 upon application of the pressing operation, the intermediate element 110 is driven by the button 104 to press the pressed portion 113 of the switch 112, so as to switch the switch 112 to the on state, and after the switch 112 is switched to the on state, the intermediate element 110 allows the button 104 to continue moving toward the switch 112 for a distance. Thus, after the switch 112 generates the unlocking signal, the operator can still press the button 104.

In the illustrated embodiment, two ends of the push rod 111 are operatively engaged with the button 104 and the intermediate element 110, respectively, the button 104 transmits the pressing force to the intermediate element 110 via the push rod 111, and the intermediate element 110 in turn transmits the pressing force to the pressed portion 113 of the switch 112. In other embodiments, instead of the push rod 111, a protrusion may be provided on an inner side of the button 104 for pushing the intermediate element 110, especially when the button 104 is configured to make a translational movement rather than a rotational movement.

In the illustrated embodiment, two push rods 111 are provided, i.e., a push rod 111a and a push rod 111b, respectively. Two guide holes 135 are provided, i.e., a guide hole 135a and a guide hole 135b, respectively. Two return springs 117 are provided, i.e., a return spring 117a and a return spring 117b, respectively. Two pressed portions 113 are provided, i.e., a pressed portion 113a and a pressed portion 113b, respectively. Two triggered portions 141 are provided, i.e., a triggered portion 141a and a triggered portion 141b, respectively. The above components or features are arranged symmetrically with respect to a center line of the switch device 100.

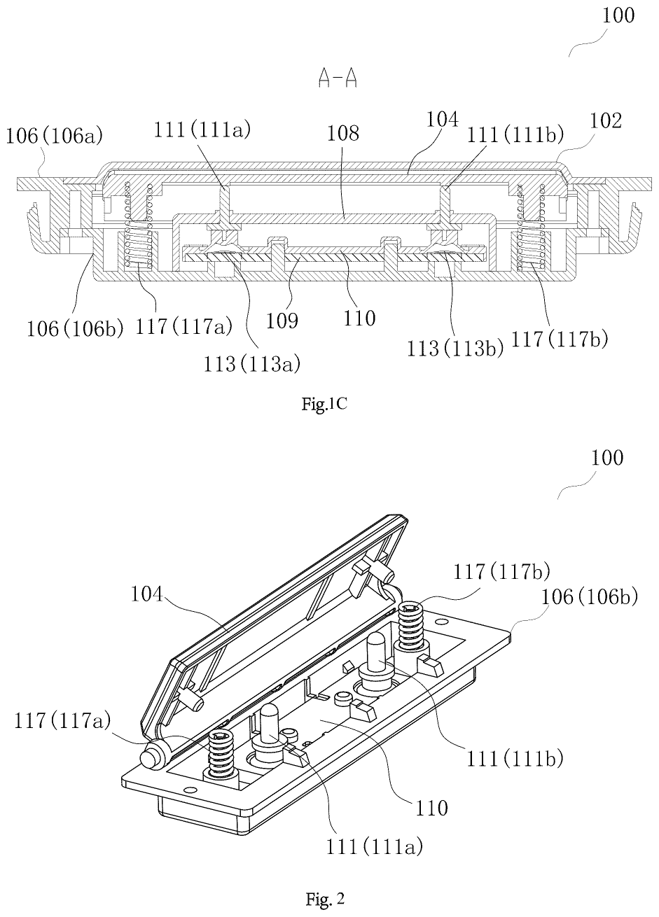

FIG. 2 is a schematic view of the switch device 100, with some components removed. In FIG. 2, the button cover 102, the upper housing 106a, and the inner cover 108 of the switch device 100 are hidden to more clearly show the assembling relationship between components in a housing cavity.

As shown in FIG. 2, in the switch device 100, the return spring 117 is arranged between the button 104 and the lower housing 106b. When the button 104 is subjected to the pressing force, the button 104 rotates and compresses the return spring 117, and the return spring 117 provides a biasing force for reverse movement to the button 104 to bias the button 104 toward an initial position (unpressed position) of the button. The push rod 111 is arranged between the button 104 and the intermediate element 110, such that opposite ends of the push rod abut against the button 104 and the intermediate element 110, respectively, so as to transmit the pressing force from the button 104 to the intermediate element 110. The intermediate element 110 rests on a bottom of the lower housing 106b.

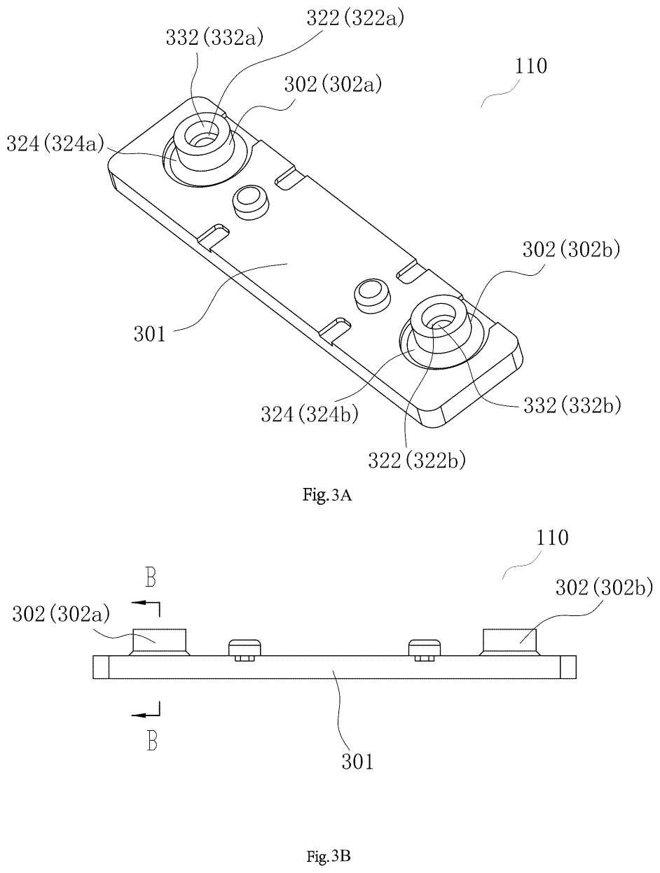

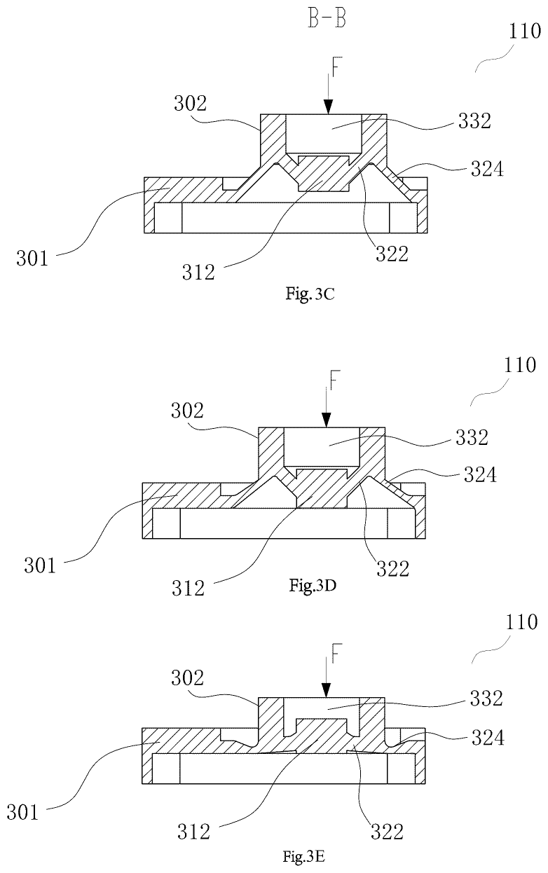

FIGS. 3A-3E show a specific structure and different states of the intermediate element 110. FIG. 3A is a perspective view of the intermediate element 100, FIG. 3B is a side view of the intermediate element 100, and FIGS. 3C-3E are cross-sectional views of the intermediate element 100 along line B-B in FIG. 3B, showing the intermediate element being in an undeformed state, an intermediate deformed state, and a final deformed state, respectively.

In the illustrated embodiment, the intermediate element 110 is formed in one piece from an elastic material (e.g., rubber), so that the intermediate element can undergo elastic deformation when subjected to the pressing force. The intermediate element 110 has a structure that is arranged symmetrically with respect to a center line thereof.

As shown in FIGS. 3A-3B, the intermediate element 110 includes a holding portion 301, a transmission portion 302 (302a, 302b), a pressing portion 312 (312a, 312b), a first deformable connection portion 322 (322a, 322b), and a second deformable connection portion 324 (324a, 324b). The transmission portion 302 is drivingly connected to the button. The transmission portion 302a, the pressing portion 312a, the first deformable connection portion 322a, and the second deformable connection portion 324a together form a first set of sub-elements, and the transmission portion 302b, the pressing portion 312b, the first deformable connection portion 322b, and the second deformable connection portion 324b together form a second set of sub-elements. The two sets of sub-elements are held in the housing 106 by the holding portion 301. In the illustrated embodiment, the holding portion 301 is a base, which is generally in the shape of a plate with a certain thickness and is supported by a bottom of the housing 106.

Still as shown in FIGS. 3A-3B, the transmission portion 302 is tubular and includes a cavity 332 (332a, 332b) for receiving the pressing portion 312. The push rod described above is arranged between the button and the transmission portion 302 of the intermediate element 110, such that an end of the push rod abuts against a top of the transmission portion 302 to transmit the pressing force from the button to the transmission portion 302. The first deformable connection portion 322 connects the transmission portion 302 to the pressing portion 312. The second deformable connection portion 324 connects the holding portion 301 to the transmission portion 302 and maintains the pressing portion 312 in an initial position in which the pressed portion of the switch is not pressed. The pressing portion 312 is operatively engaged with the pressed portion of the switch and is generally cylindrical. Each of the first deformable connection portion 322 and the second deformable connection portion 324 extends obliquely relative to a direction of movement of the transmission portion 302. Therefore, in cross-section, the first deformable connection portion 322 and the second deformable connection portion 324 together form a corrugated shape. It should be understood by those skilled in the art that, in other embodiments, the second deformable connection portion 324 may also connect the holding portion 301 to the pressing portion 312 or the first deformable connection portion 322, as long as the transmission portion 302 and the pressing portion 312 can move relative to the holding portion 301.

During application of the pressing operation, the button has a first-stage stroke and a second-stage stroke. In the first-stage stroke, the button drives both the transmission portion 302 and the pressing portion 312 to move toward the switch, so that the pressed portion of the switch is pressed by the pressing portion 312. In the second-stage stroke, the button continues driving the transmission portion 302 to move toward the switch, and the pressing portion 312 is blocked by the pressed portion of the switch and stops moving. As a result, the pressing portion 312 is gradually received into the cavity 332, and during this process, the pressing portion 312 keeps pressing the pressed portion of the switch.

As shown in FIGS. 3C-3E, in the first-stage stroke of the button, when the transmission portion 302 is subjected to the pressing force F, the second connection portion 324 first undergoes clastic deformation, causing the transmission portion 302 to move downward and enabling the transmission portion to drive the pressing portion 312 to move downward together via the first deformable connection portion 322. The pressing portion 312 exerts a pressure on the pressed portion of the switch during downward movement, causing elastic deformation of the pressed portion to switch the switch to the on state. In the second-stage stroke, the pressing portion 312 is blocked by the pressed portion 113 and cannot continue moving downward (see FIG. 3D), and the transmission portion 302 can continue moving downward under the action of the pressing force F, thus displacing downward relative to the pressed portion 113. The first deformable connection portion 322 deforms due to the movement of the transmission portion 302, the tubular cavity 332 of the transmission portion 302 moves downward and sleeved outside the pressing portion 312, so that the pressing portion 312 is gradually received into the cavity 332. The transmission portion 302 continues moving downward until it is blocked by the switch and stops moving.

It should be understood by those skilled in the art that although in the illustrated embodiment, the intermediate element 110 is formed in one piece from an elastic material (e.g., rubber), in other embodiments, the intermediate element 110 may also be made of an elastic material (e.g., rubber) only at the first deformable connection portion 322 and the second deformable connection portion 324.

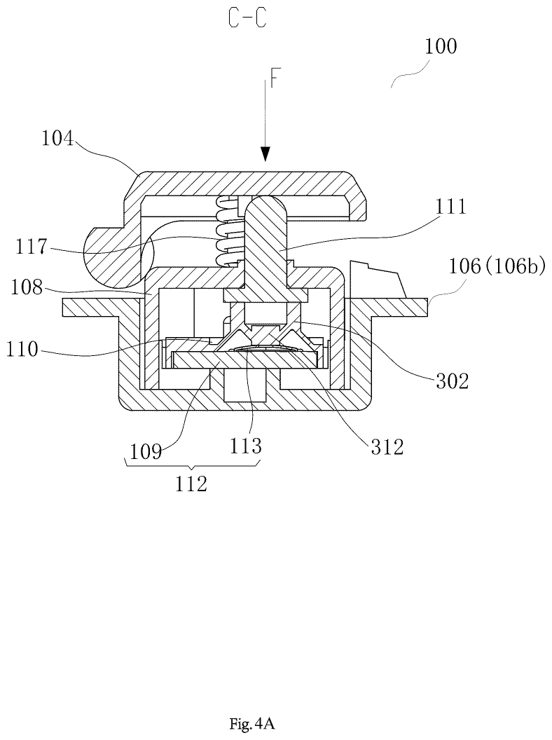

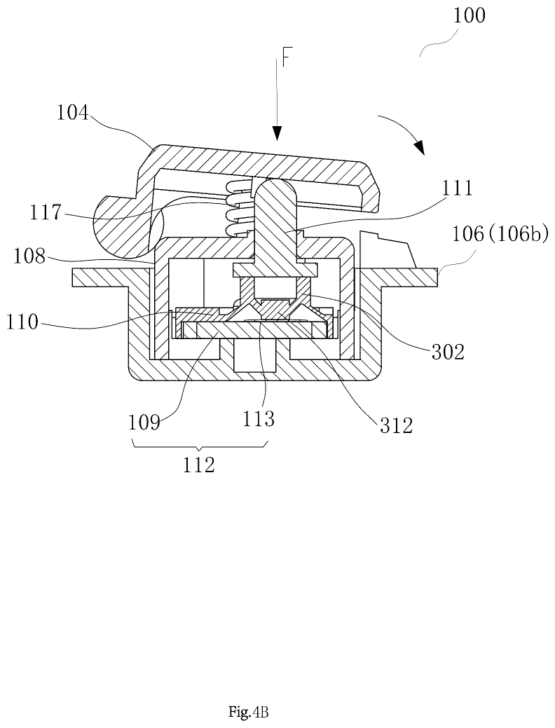

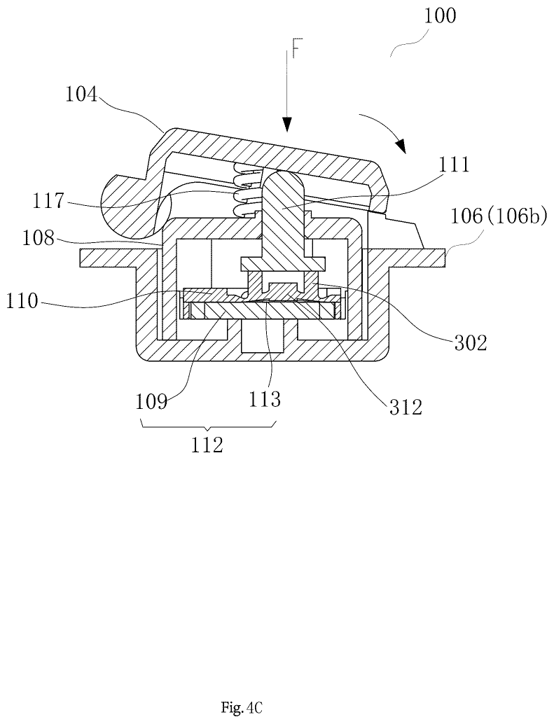

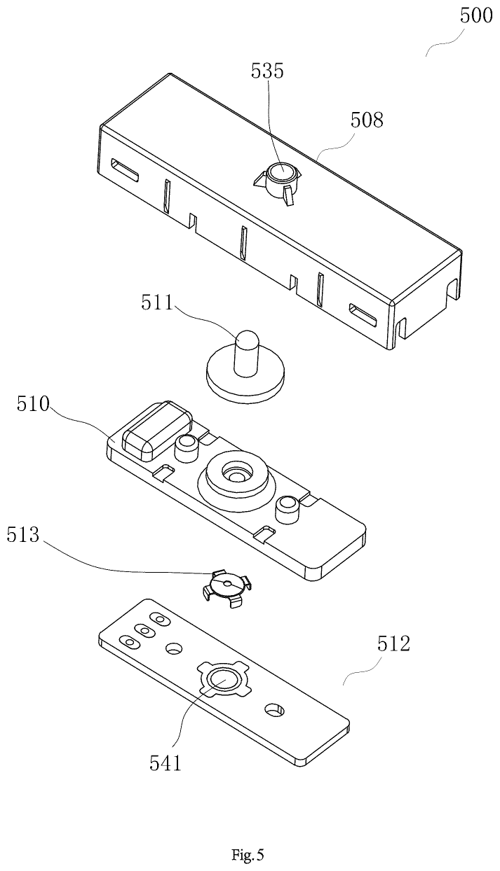

FIGS. 4A-4C show cross-sectional views along line C-C in FIG. 1B during operation of the switch device 100. In FIG. 4A, the switch device 100 is in an unpressed state, in FIG. 4B, the switch device 100 is in an intermediate pressed state, and in FIG. 4C, the switch device 100 is in a fully pressed state. To more clearly show the fitting relationship between components of the switch device, the upper housing 106a and the button cover 102 are omitted in FIGS. 4A-4C.

As shown in FIGS. 4A-4B, in the first-stage stroke of the button 104, when a user applies the pressing force F to the switch device 100, the button 104 rotates downward. The rotation of the button 104 can transmit the pressing force to the push rod 111, and the push rod 111 passes through the inner cover 108 to transmit the pressing force to the transmission portion 302 of the intermediate element 110 to move the transmission portion downward. The downward movement of the transmission portion 302 can drive the pressing portion 312 to move downward, thereby exerting the pressure on the pressed portion 113 of the switch 112 to make it come into contact with an unlocking trigger section on the circuit board 109, and thus turning on the switch and generating an unlocking signal. In the embodiment of the present disclosure, to turn on the switch 112, the transmission portion 302 moves downward by 0.3 mm (see a state shown in FIG. 4B) in response to the first-stage stroke of the button 104.

As shown in FIGS. 4B-4C, in the second-stage stroke of the button 104, the push rod 111 can continue pushing the transmission portion 302 to move downward by 1.2 mm (see a state shown in FIG. 4C), where the pressing portion 312 maintains the state of pressing the pressed portion 113, so that the switch remains in the on state. Since the return spring 117 provides a reverse biasing force to the button 104, the button 104 has a tendency to move toward the initial position. Therefore, when the user no longer applies the pressing force F, the button 104 returns to the initial position (as shown in FIG. 4A) under the action of the biasing force.

When the pressing operation is applied, the operator (or user) usually presses the button 104 down to the bottom in a single operation, that is, the switch device 100 is directly pressed from the state shown in FIG. 4A to the state shown in FIG. 4C. During pressing, the switch device 100 generates an unlocking signal when in the intermediate pressed state shown in FIG. 4B to perform a physical unlocking operation. The time required for the pressing process from the intermediate pressed state shown in FIG. 4B to the fully pressed state shown in FIG. 4C is the same as the time required for the physical unlocking operation (for example, approximately 1 to 2 seconds). Throughout the entire process, the user's experience is that as long as the button 104 is pressed to the bottom, the unlocking operation of a door is completed, allowing the door to be pulled open without waiting for additional time to unlock the door after pressing the button 104.

FIG. 5 is an exploded view of a switch device according to a second embodiment of the present disclosure. To more clearly show the difference between the second embodiment and the first embodiment, the button cover, the button, the housing and the return spring of the switch device are hidden in FIG. 5.

The second embodiment shown in FIG. 5 differs from the first embodiment shown in FIGS. 1 to 4C only in that, in the first embodiment of the switch device 100 shown in FIGS. 1 to 4C, the intermediate element 110 includes two sets of sub-elements, and in the second embodiment of the switch device 500 shown in FIG. 5, the intermediate element 510 includes only one set of sub-elements. Accordingly, only one pressed portion 513 and one triggered portion 541 need to be provided on the switch 512, only one push rod 511 need to be provided in the switch device 500, and only one guide hole 535 need to be provided in the inner cover 508 to accommodate the push rod 511.

It should also be understood by those skilled in the art that, based on the same concept as the previous embodiment, more than two sets of sub-elements may also be provided on the intermediate element, and accordingly, more than two pressed portions, more than two triggered portions, more than two push rods and more than two guide holes need to be provided.

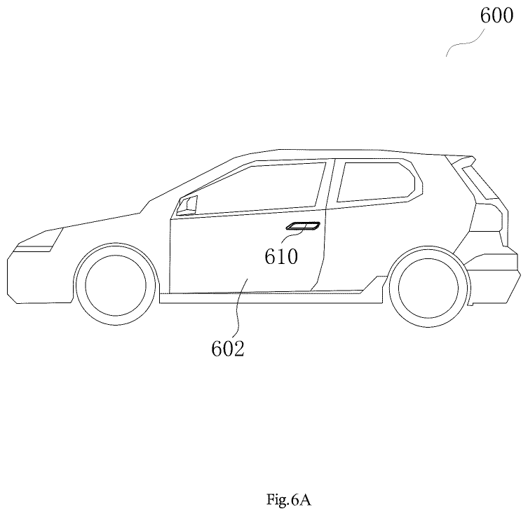

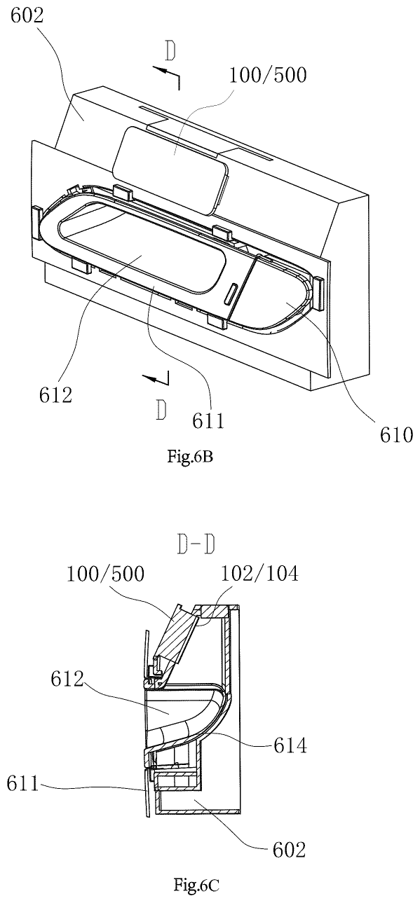

FIGS. 6A-6C show a schematic view of the switch device mounted on the door. FIG. 6A is a schematic view of a vehicle having a switch device of the present disclosure; FIG. 6B is a partial perspective view of the switch device of the present disclosure mounted on the door; and FIG. 6C is a cross-sectional view of the switch device of the present disclosure mounted on the door along line D-D.

As shown in FIG. 6A, a vehicle 600 has a handle device 610 arranged on a door 602 for opening the door 602. The handle device 610 is provided with the switch device as described above, and the switch device is configured to generate an unlocking signal indicating that the door 602 is to be unlocked upon application of a pressing operation on the button.

As shown in FIGS. 6B-6C, the handle device 610 includes a handle seat 611 having a handle cavity 612. The button 104 of the switch device 100/500 is arranged in the handle cavity 612 of the handle seat 611, allowing the pressing operation applied to the button 104 to be performed in the handle cavity 612. Specifically, the handle cavity 604 has an upwardly curved cavity bottom wall 614 for guiding the user's fingers into the handle cavity 604. When the user's fingers extend into the handle cavity 604 inward and upward and reach the deepest position of the handle cavity 604, the button cover 102 of the switch device 100/500 can be touched, so that an unlocking operation can be performed by pressing the button 104.

The vehicle 600 is further provided with a control device (not shown), which can receive the unlocking signal transmitted by the switch device and control a lock rod to perform the unlocking operation.

The switch device of the present disclosure enables the button to have a longer pressing stroke by arranging an at least partially deformable intermediate element for transmitting the pressing force between the button and the pressed portion of the switch. During pressing of the button, the switch can be turned on to generate an unlocking signal before the button is pressed to the bottom. After the switch is turned on, the intermediate element can allow the button to continue moving toward the switch for a distance through deformation, and the time required for this process is the same as the time required for the physical unlocking of the lock rod. Thus, the lag time of the unlocking operation of the lock rod is compensated, so that the time when the pressing is completed is synchronized with the time when the lock rod completes unlocking. This allows the user to pull open the door without waiting for the lock rod to unlock after pressing the switch, resulting in a better user experience.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting; therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or substantial equivalents.

List of reference numbers:

| | |
|---|---|
| Switch device | 100/500 |
| Button cover | 102 |
| Button | 104 |
| Housing | 106 |
| Opening | 107 |
| Inner cover | 108/508 |
| Circuit board | 109 |
| Intermediate element | 110/510 |
| Push rod | 111/511 |
| Switch | 112/512 |
| Pressed portion | 113/513 |
| Pivot shaft | 132 |
| Triggered portion | 141/541 |
| Return spring | 117 |
| Guide hole | 135/535 |
| Holding portion | 301 |
| Transmission portion | 302 |
| Pressing portion | 312 |
| First deformable connection portion | 322 |
| Second deformable connection portion | 324 |
| Cavity | 332 |
| Vehicle | 600 |
| Door | 602 |
| Handle device | 610 |
| Handle seat | 611 |
| Handle cavity | 612 |
| Cavity bottom wall | 614 |

What is claimed is:

1. A switch device, comprising:
a housing having an opening;
a switch comprising a pressed portion and accommodated in the housing, the switch being switched between an off state and an on state in response to a pressing force acting on the pressed portion;
a button coupled to the housing at the opening and movable toward the switch upon application of a pressing operation; and
an intermediate element, the intermediate element being at least partially deformable, being drivingly connected to the button, and being operatively engaged with the pressed portion of the switch;
wherein the intermediate element is configured such that when the button is moved toward the switch upon application of the pressing operation, the intermediate element is driven by the button to press the pressed portion of the switch, so as to switch the switch to the on state, and after the switch is switched to the on state, the intermediate element allows the button to continue moving toward the switch for a distance.

2. The switch device according to claim 1, wherein the intermediate element comprises:
a transmission portion drivingly connected to the button;
a pressing portion operatively engaged with the pressed portion of the switch;
a holding portion holding the intermediate element in the housing;
a first deformable connection portion connecting the transmission portion to the pressing portion; and
a second deformable connection portion connecting the holding portion to one of the transmission portion, the pressing portion and the first deformable connection portion, and retaining the pressing portion in an initial position in which the pressed portion of the switch is not pressed.

3. The switch device according to claim 2,
wherein, during application of the pressing operation, the button has a first-stage stroke and a second-stage stroke;
wherein in the first-stage stroke, the button drives both the transmission portion and the pressing portion to move toward the switch, so that the pressed portion of the switch is pressed by the pressing portion; and
wherein in the second-stage stroke, the button continues driving the transmission portion to move toward the switch, and the pressing portion retains pressing the pressed portion of the switch.

4. The switch device according to claim 2, wherein each of the first deformable connection portion and the second deformable connection portion extends obliquely relative to a direction of movement of the transmission portion.

5. The switch device according to claim 3, wherein the transmission portion is tubular and comprises a cavity, wherein in the second-stage stroke, the pressing portion is gradually received into the cavity.

6. The switch device according to claim 2, wherein the holding portion is a base supported by a bottom of the housing.

7. The switch device according to claim 6, wherein the transmission portion, the pressing portion, the first deformable connection portion, and the second deformable connection portion together form a set of sub-elements, the intermediate element comprises two sets of sub-elements, and the two sets of sub-elements are held in the housing by the holding portion.

8. The switch device according to claim 7, wherein the intermediate element is formed in one piece from an elastic material.

9. The switch device according to claim 2, further comprising:
a push rod, the push rod being arranged between the button and the transmission portion of the intermediate element, such that opposite ends of the push rod abut against the button and the transmission portion of the intermediate element, respectively, so as to transmit the pressing force from the button to the transmission portion of the intermediate element.

10. The switch device according to claim 9, wherein the button is rotatably connected to the housing to rotate toward the switch upon application of the pressing operation.

11. The switch device according to claim 9, further comprising:
a return spring arranged to bias the button toward an initial position of the button.

12. The switch device according to claim 11, further comprising:
an inner cover arranged in the housing and covering the intermediate element, the switch, and part of the push rod;
wherein a guide hole is provided in the inner cover, the push rod extends out of the inner cover through the guide hole, and the button and the return spring are arranged outside the inner cover.

13. A handle device for a door,
wherein the handle device is provided with a switch device according to claim 1, the switch device being configured to generate an unlocking signal indicating that the door is to be unlocked upon application of the pressing operation on the button.

14. The handle device according to claim 13, comprising:
a handle seat comprising a handle cavity;
wherein the switch device is arranged in the handle seat in such a way that the button is located in the handle cavity, allowing the pressing operation applied to the button to be performed in the handle cavity.

15. A vehicle, comprising the handle device of claim 14.
